(19) United States
(12) Patent Application Publication
(10) Pub. No.: US 2007/0029803 A1
(43) Pub. Date: Feb. 8, 2007

(54) Machine for transferring power and producing electricity in a jet engine

(76) Inventor: Edward Rigor Randall, Ocala, FL (US)

Correspondence Address: EDWARD RANDALL, Apt. 3511, 5001 SW 20th St., OCALA, FL, 34474, US

(21) Appl. No.: 11/197,689

(22) Filed: Aug. 4, 2005

(51) Int. Cl. F01D 15/10; H02K 5/12; H02K 7/09

(52) U.S. Cl. 290/52; 310/86; 310/90.5

(57) ABSTRACT

A machine for transferring power and producing electricity in a jet engine. with a ring connecting the tips of the compressor and turbine blades containing embedded high energy magnets, a set of coils for each rotating stage of the engine in the outer engine case, a power transfer and distribution system, a control system to regulate the engine and energy distribution, a ultracapacitor and efficient battery storage system, a set of magnetic bearings for each rotating stage, and a cooling system for the first couple turbine stages to keep the magnets from melting.

### BACKGROUND OF THE INVENTION

This invention relates generally to the field of turbine engines and more specifically to a machine for transferring power and producing electricity in a turbine engine.

Jet engines were invented back in the 1930's. They enable higher speeds in aircraft up to and above the speed of sound. The jet engine also provides a source of electrical power for the aircraft. Turbine engines are also used in ships, vehicles, and to generate electrical power.

Magnets and the electric motor have been in use since the early 1900'S. The main enabling technology is the invention of high energy density magnets capable of generating large amounts of power in a small package. High power switching systems, compact transmission systems and new electrical storage systems are also enabling technologies. These technologies were developed in the 1980's and 1990's.

Jet engines have used a shaft to connect the compressor and turbine. The stages are separated by pressure. A different shaft is used for high, medium, and low pressure areas of the engine. Electrical power is generated by a power take off shaft connected to the main shaft. The power takeoff shaft is connected to a generator.

A shaft connecting the turbine and compressor limits the compressor and turbine. All the stages connected to a shaft rotate at the same speed. Variations in the air flow can't be adapted to by the rotating compressor or turbine stages. Efficiency of a jet engine is limited by the lack of adjustable rotor stages. The various shafts and bearings also add weight to a jet engine. A power take off shaft used to generate electricity can disrupt airflow and cause compressor stall. External generators add weight and complexity to a jet engine.

### BRIEF SUMMARY OF THE INVENTION

The primary object of the invention is to connect the turbine and compressor using electricity. Another object of the invention is to eliminate the shaft in a jet engine reducing weight by approximately ⅓. Another object of the invention is to eliminate shaft driven generators reducing total weight and system complexity. A further object of the invention is to increase engine electrical output for auxiliary systems. Yet another object of the invention is to create a modular system where electrical output could be increased or decreased by adding or removing turbine stages. Still yet another object of the invention is to enable control of each compressor stage individually increasing efficiency.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a machine for transferring power and producing electricity in a jet engine comprising: a ring connecting the tips of the compressor and turbine blades containing embedded high energy magnets, a set of coils for each rotating stage of the engine in the outer engine case, a power transfer and distribution system, a control system to regulate the engine and energy distribution, a ultracapacitor and efficient battery storage system, a set of magnetic bearings for each rotating stage, and a cooling system for the first couple turbine stages to keep the magnets from melting.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

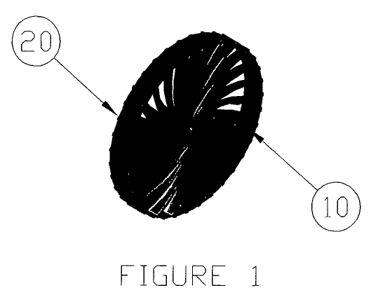

In accordance with the present invention, FIG. 1 shows a typical rotating engine stage. The ring 10 connecting the turbine blades contains high energy magnets 20. Compressor and Turbine stages are similar in design except for the shape of the blades.

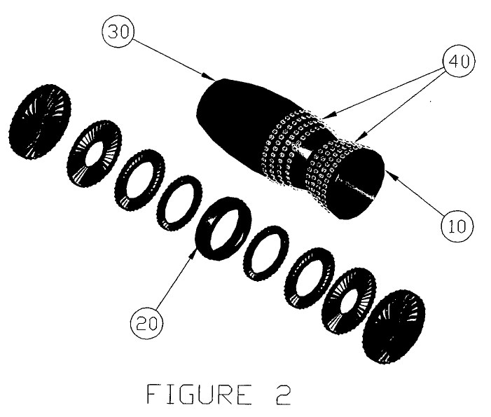

In accordance with the present invention, FIG. 2 shows a exploded view of a turbine engine. The inlet nozzle 10, combustor 20, and exhaust nozzle 30 are similar to other turbine engines. Windings 40 are located in the outer engine case. The combination of windings and high-energy magnets enable the turbine to act as a generator and the compressor to act as a electric motor.

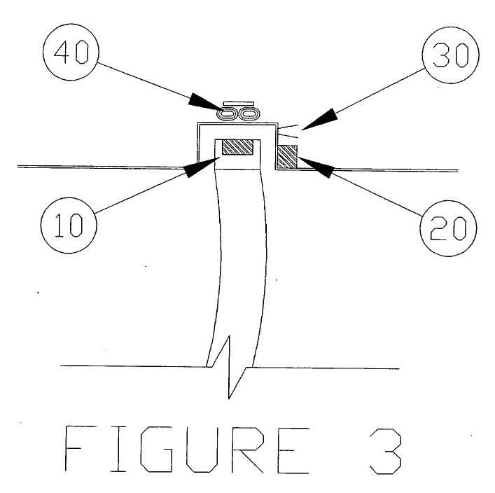

In accordance with the present invention, FIG. 3 shows a cross sectional view of a typical assembled rotating turbine stage. The view shows the relative location of the high energy magnets 10, the magnetic bearings 20 to support the rotating stage, the turbine cooling system 30 to keep the magnets from melting, and the windings 40 in the outer engine case.

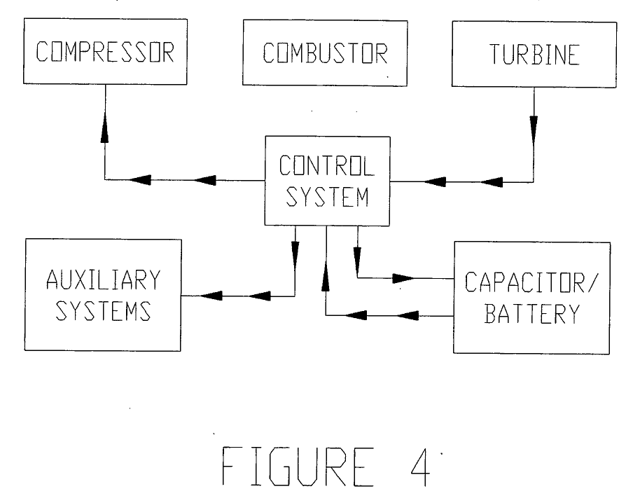

In accordance with the present invention, FIG. 4 shows a flow diagram for system energy. Electrical power flows from the turbine to the control system. The control system transfers the majority of the power to the compressor to continue engine operation. The control system distributes the remaining power either to auxiliary systems or to a ultracapacitor/battery system depending on demand. Power can flow in both directions so that stored energy can be used start the turbine engine.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for transferring power and producing electricity in a jet engine comprising:
a ring connecting the tips of the compressor and turbine blades containing embedded high energy magnets;
a set of coils for each rotating stage of the engine in the outer engine case;
a power transfer and distribution system;
a control system to regulate the engine and energy distribution;
a ultracapacitor and efficient battery storage system;
a set of magnetic bearings for each rotating stage; and
a cooling system for the first couple turbine stages to keep the magnets from melting.
